(19) United States
(12) Patent Application Publication
(10) Pub. No.: US 2005/0017404 A1
(43) Pub. Date: Jan. 27, 2005

(54) Method of molding a vehicle trim component

(76) Inventors: John D. Youngs, Southgate, MI (US); David J. Dooley, Troy, MI (US)

Correspondence Address: MACMILLAN, SOBANSKI & TODD, LLC, ONE MARITIME PLAZA-FOURTH FLOOR, 720 WATER STREET, TOLEDO, OH, 43604, US

(21) Appl. No.: 10/623,951

(22) Filed: Jul. 21, 2003

(51) Int. Cl. B29C 45/14

(52) U.S. Cl. 264/255

(57) ABSTRACT

A method of forming a decorative surface feature on an article formed in a mold includes providing a mold assembly. The mold assembly includes a first mold portion having a textured surface, and a second mold portion, wherein the first and the second mold portions define a mold cavity. A first material is then heated and introduced the into the mold cavity. The mold cavity is then closed. A second material is introduced into the mold cavity, such that an imprint of the textured surface of the first mold portion is transferred to the first material, thereby forming an article having a decorative surface feature formed thereon. Preferably, the introduction of the second material into the cavity applies a force on the first material, such that the first material is moved into contact with the textured surface of the first mold portion.

### BACKGROUND OF THE INVENTION

This invention relates in general to vehicle trim components, such as instrument panels, and in particular relates to a method of manufacturing such.

The interior of the vehicle includes a multitude of components for covering various frameworks, instruments, and electrical devices mounted within the interior compartment of a vehicle. Examples of trim components include instrument panels, door panels, center consoles, overhead consoles, and other various interior panels for covering the sides, ceilings, and vertical pillars of the frame members of the vehicle.

The instrument panel is generally positioned underneath the windshield and attached to the frame of the vehicle behind the engine compartment. The instrument panel encloses various vehicle components, such as electrical and ventilation systems, audio systems, vehicle instrument gauges and displays, and auxiliary compartments.

In the past, the trim components, such as instrument panels, were made of metal or plastic and commonly had rigid exterior upper and rear surfaces facing the interior of the vehicle. The upper and rear surfaces of the instrument panel are within reach and direct sight of the occupants of the vehicle. Recently, consumers have been demanding a more aesthetically pleasing exposed surface. It is also preferred that the tactile properties of the surfaces are also more pleasing, such as having soft or elastic properties compared to a relatively rigid surface. Thus, the area of the instrument panel located at the upper and lower surfaces of the instrument panel have been covered in a suitably soft material over the rigid structurally accommodating framework of the instrument panel.

In a known method of manufacturing a trim component such as an instrument panel, a rigid plastic substrate is first formed by an injection molding process. The rigid substrate is produced and generally contoured to conform to the general shape of the finished instrument panel. Next, indicia, such as faux leather grain, is embossed onto a relatively soft material, such as vinyl. The vinyl is then cooled and/or cured to form a relatively flexible covering material. The covering material is then later adhesively or otherwise attached to the rigid substrate, such as by a method commonly known as vacuum forming. This method of manufacturing produces an instrument panel having structural rigidity essentially from the rigid substrate, yet having an outer softer covering.

However, the covering material is typical stretched when it is applied to the contours of the rigid substrate, causing the indicia in the surface of the covering material to become undesirably stretched and distorted. Accordingly, it is desirable to provide an improved method of forming indicia on an article formed in a mold.

### BRIEF SUMMARY OF THE INVENTION

This invention relates to a method of forming a decorative surface feature on an article formed in a mold. The method includes providing a mold assembly comprising a first mold portion having a textured surface, and a second mold portion, wherein the first and the second mold portions a cavity. The first material is then heated and introduced into the cavity. The mold cavity is then closed. A second material is introduced into the cavity, such that an imprint of the textured surface is transferred to the first material, thereby forming an article having a decorative surface feature or grain formed thereon. Preferably, the introduction of the second material into the cavity applies a force on the first material, such that the first material is moved into contact with the textured surface of the first mold portion.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a schematic cross sectional elevational view of a mold assembly used in accordance with the method of this invention, showing the mold assembly in the open position.

FIG. 2 is a schematic cross sectional elevational view of the mold assembly illustrated in FIG. 1 in the closed position, showing a vehicle trim component having a decorative surface feature thereon.

### DETAILED DESCRIPTION OF THE INVENTION

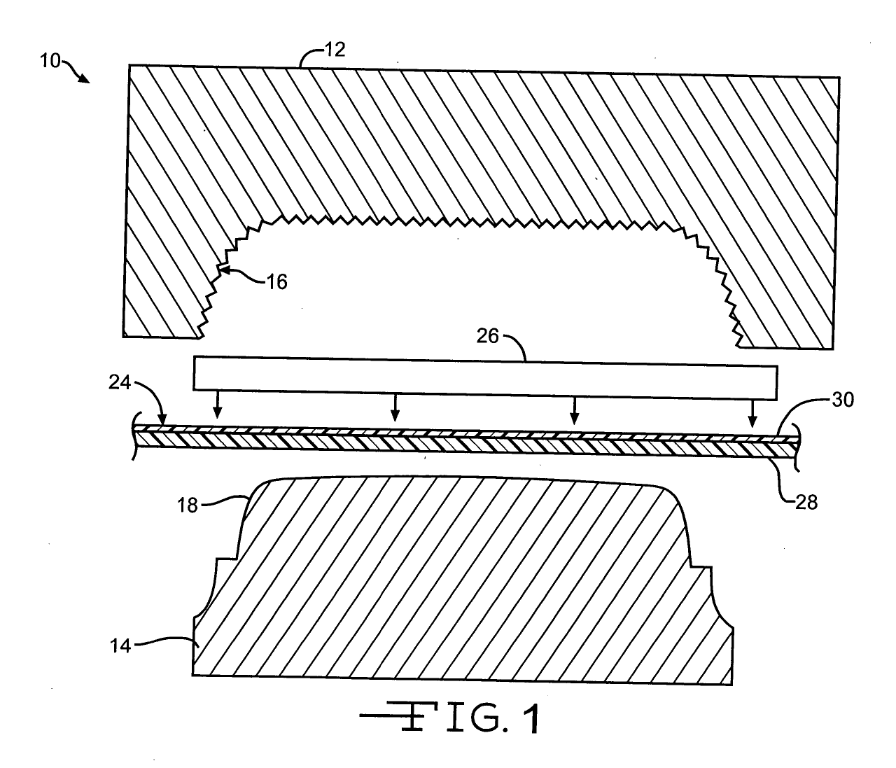

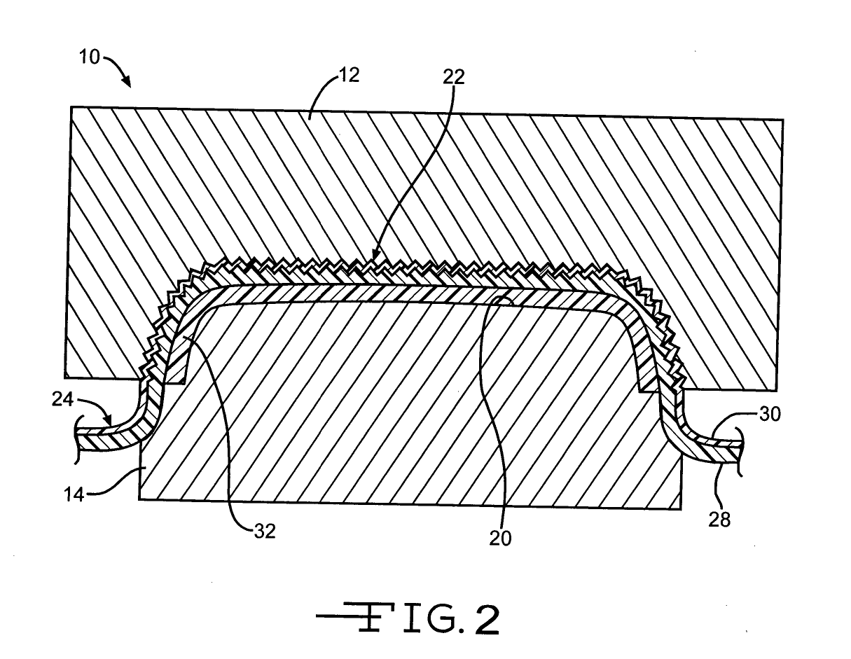

Referring now to FIGS. 1 and 2, there is illustrated a mold assembly, indicated generally at 10, which is adapted to be used in accordance with the method of this invention. Typically, the mold assembly 10 includes a first mold portion or mold cavity portion 12, and a second mold portion or mold core 14. The mold cavity portion 12 includes a cavity surface 16, and the mold core 14 includes a corresponding mold core surface 18. The mold cavity portion 12 and the mold core 14 are relatively movable between an open position, as shown in FIG. 1, and a closed position, as shown in FIG. 2. When in the closed position, the mold cavity portion 12 and the mold core 14 define a mold cavity 20, as best shown in FIG. 2.

Although illustrated schematically in FIGS. 1 and 2 it will be appreciated that the cavity surface 16 and the core surface 18 may be of any desired shape and contour. The mold cavity portion 12 and the mold core 14 are preferably mounted to platens (not shown) of a press (not shown), such as a vertical or horizontal molding press with sufficient tonnage to accomplish the method herein described.

Preferably, the cavity surface 16 is a textured surface. As used herein, textured surface is defined as an irregular or regular, non-smooth surface, such as a random grainy pattern, a grooved pattern, a dimpled pattern, a leather grain pattern, logos such as letters and numerals, decorative indicia and the like.

As shown in FIGS. 1 and 2, inclusive, an article, such as a vehicle trim component, is formed by the mold assembly 10. In the embodiment illustrated, the exemplary vehicle trim component is shown as an instrument panel 22. Although the method of manufacturing an article in accordance with the present invention will be described and shown in FIGS. 1 and 2 with respect to the instrument panel 22, it should be understood that the method may be practiced to form any type of trim component or portions of components for a vehicle formed of at least two different materials, such as a coverstock and a substrate. The instrument panel 22 is one example of a trim component for mounting in an interior cabin of a vehicle. Other suitable examples of trim components which can be formed from the present invention include door panels, center consoles, overhead consoles, and other various interior panels for covering the sides, ceilings, and/or vertical pillars of the frame members of the vehicle.

It will be appreciated, that in accordance with the method of the invention as will be described below, a first step of the method of the invention includes providing a suitable mold assembly 10.

A second step of the method of this invention is illustrated in FIG. 1. In the second step, the mold cavity portion 12 and the mold core 14 are moved outwardly of each other and into the open position. A first material or coverstock 24 is then heated by a source of heat 26 and introduced or disposed within the mold cavity 20. Preferably the coverstock 24 is a plastic material having a generally elastic characteristic. More preferably, the coverstock 24 formed from thermoplastic olefin (TPO) or from vinyl.

As shown in FIGS. 1 and 2, the coverstock 24 is illustrated as a bilaminate material, and includes an inner layer 28 and an outer layer 30. The outer layer 30 is preferably made of a softer material than the inner layer 28 and has a generally soft tactile feel. The outer layer 30 preferably faces the interior of the vehicle and is generally viewable by a vehicle occupant. Preferably, the inner layer 28 comprises polypropylene foam and the outer layer 30 comprises one of a layer of TPO or a layer of vinyl. It will be appreciated that the inner and outer layers 28 and 30, respectively, can also be formed of any desired materials. It will be further understood that the coverstock 24 can be also formed from any desired number of layers, such as a trilaminate, or as a single layer of material (not shown), such as a layer of TPO or a layer of vinyl.

It will be appreciated that the source of heat 26 can be any desired source of heat, suitable for heating the coverstock 24 to a desired temperature. As used herein, the desired temperature is defined as the temperature required to heat the coverstock 24, such that the coverstock 24 is embossable as described herein.

Although the source of heat 26 is schematically illustrated as disposed between the mold cavity portion 12 and the mold core 14, it will be appreciated that the source of heat 26 can be positioned at any desired location relative to the mold assembly 10. For example, the source of heat 26 can be adjacent the mold assembly 10, such that the coverstock 24 is heated and subsequently moved into the mold assembly. Alternately, a movable source of heat 26 can be provided, wherein the source of heat 26 and the coverstock 24 are initially disposed within the mold assembly 10. The coverstock 24 is then heated and the source of heat 26 moved outward of the mold assembly 10. It will be further appreciated that the source of heat 26 can be integral with either or both of the mold cavity portion 12 and the mold core 14.

In a third step of the method of the invention, the mold assembly 10 is moved to the closed position as shown in FIG. 2. A second material 32 is then introduced into the mold cavity 20 through an inlet (not shown) in the mold assembly 10 to form a substrate having a generally rigid characteristic for supporting the first material 24. Alternately, the second material 32 can be poured into the mold cavity 20, such as in an open pour technique or rapid injection molding process.

Preferably the second material 32 is molten plastic or a thermoset material which hardens to form a substantially rigid plastic material when cool. More preferably, the second material 32 is a material such as polypropylene, TPO, acrylonitrile butadiene styrene (ABS), or polyurethane. As shown in FIG. 2, the mold cavity 20 is filled with the second material 32. The second material 32 then conforms to the shape of the mold cavity 20, thereby forming the instrument panel 22. The instrument panel 22 is then removed from the mold assembly 10 by any suitable method (not shown).

It should be understood that the second material 32 can be introduced into the mold assembly 10 at any suitable temperature and pressure. Additionally, both the first and second materials 24 and 32 can be introduced into the mold assembly 10 with or without any other desired materials, such as for example, an adhesive promoter to form a bond between the first and second materials 24 and 32.

During the introduction of the second material 32 into the mold cavity 20, a force is exerted (upwardly as viewed in FIG. 2), on the coverstock 24 by the pressurized second material 32. Surprisingly, such a force will move the coverstock against the textured cavity surface 16 of the mold cavity portion 12, such that an imprint of the textured surface is transferred to the coverstock 24.

In commonly known methods of applying an embossed coverstock to a rigid substrate, the embossed indicium is stretched and often undesirably distorted. Additionally, such known methods require multiple process steps and multiple tools, such as for example, applying the indicium to the coverstock in a first mold, then subsequently moving the coverstock to a second mold, and applying the coverstock to a rigid substrate.

According to the method described herein, the indicium, such as leather grain, is transferred to the coverstock 24 during formation of the substrate, substantially without any stretching or distortion of the grain, as occurs in the known methods. Additionally, according to the method described herein, a molded article having a decorative surface feature, such as the embossed vehicle instrument panel 22, can be formed in a single mold assembly 10 and in a single molding operation.

Although the method of the invention has been described in the context of a low pressure injection molding process, it will be understood that other desired molding methods can be used, such as a reaction injection molding process, as would be understood by those skilled in the art.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

1. A method of forming a decorative surface feature on an article formed in a mold, the method comprising the steps of:
a. providing a mold assembly comprising a first mold portion having a textured surface, and a second mold portion, the first and the second mold portions defining a cavity;
b. heating a first material;
c. introducing the first material into the cavity;
d. closing the mold cavity; and
e. introducing a second material into the cavity, such that an imprint of the textured surface is transferred to the first material, thereby forming an article having a decorative surface feature formed thereon.

2. The method of claim 1, wherein the introduction of the second material into the cavity applies a force on the first material, such that the first material is moved into contact with the textured surface of the first mold portion, thereby forming the article having a decorative surface feature formed thereon.

3. The method of claim 1, wherein the second material is introduced into the cavity by an injection molding process.

4. The method of claim 3, wherein the second material is introduced into the cavity by a low pressure injection molding process.

5. The method of claim 1, wherein the first mold portion is a mold cavity.

6. The method of claim 1, wherein the second mold portion is a mold core.

7. The method of claim 1, wherein the textured surface of first mold portion defines a decorative indicium.

8. The method of claim 1, wherein the first material is introduced into the cavity subsequent to being heated.

9. The method of claim 1, wherein the first material is heated subsequent to being introduced into the cavity.

10. The method of claim 1, further including a step (f), prior to step (b), wherein a the first material is one of a formed and a molded material so as to provide a first material having a predetermined shape.

11. The method of claim 1, further including a source of heat for heating the first material.

12. The method of claim 1, wherein the step of heating the first material occurs within the mold assembly.

13. The method of claim 1, wherein the second material has a generally rigid characteristic for structurally supporting the first material.

14. The method of claim 1, wherein the first material is made of a material selected from the group consisting of thermoplastic olefin and vinyl.

15. The method of claim 1, wherein the second material is made of a material selected from the group consisting of polypropylene, thermoplastic olefin, and acrylonitrile butadiene styrene.

16. The method of claim 1, wherein the first material comprises a plurality of layers of material.

17. The method of claim 16, wherein the first material is comprises a layer of polypropylene foam and one of a layer of thermoplastic olefin and vinyl.

18. The method of claim 1, wherein one of the first and second materials includes an adhesive promoter to form a bond between the first and second materials.

19. A method of forming a decorative surface feature on an article formed in a mold, the method comprising the steps of:
a. providing a mold assembly comprising a first mold portion having a textured surface, and a second mold portion, the first and the second mold portions defining a cavity;
b. heating a first material;
c. introducing the first material into the cavity;
d. introducing a second material into the cavity; and
e. closing the mold cavity, wherein an imprint of the textured surface is transferred to the first material, thereby forming an article having a decorative surface feature formed thereon.

20. The method of claim 19, wherein the second material is poured into the cavity.
